(19) United States
(12) Patent Application Publication
(10) Pub. No.: US 2011/0177202 A1
(43) Pub. Date: Jul. 21, 2011

(54) Colouring Composition

(75) Inventors: Christian Christiansen, Berlin (DE); Katarina Fuchs, Potsdam (DE)

(73) Assignee: RUDOLF WILD GMBH & CO. KG, Eppelheim (DE)

(21) Appl. No.: 13/006,718

(22) Filed: Jan. 14, 2011

(30) Foreign Application Priority Data
Jan. 15, 2010 (EP) 10000356.5

(51) Int. Cl. A23L 1/30; A23L 1/27; A23L 2/00; A23L 1/275

(52) U.S. Cl. 426/72; 426/540; 426/590; 426/601

(57) ABSTRACT

The present invention relates to a composition comprising:
(a) at least a colouring,
(b) at least a first emulsifying agent selected from the group of the polysorbates, and
(c) at least a second emulsifying agent, selected from the group of the esters of mono- and diglycerides of edible fatty acids,
   whereby the weight ratio (b):(c) amounts to 5:1 to 40:1.

The present invention relates to a colouring composition that is suitable for manufacturing foodstuffs and semi-finished products for foodstuffs.

There is a great deal of interest in offering foodstuffs in a manner that is appealing as regards both taste and appearance. The colour of the foodstuff represents an important selection criterion for the consumer in this connection. Colourings are therefore often added to foodstuffs that inherently have little colour of their own in order to make them attractive to the consumer. Colourings can furthermore serve to compensate for colour changes or loss of colour that occurs during the manufacturing, processing or storage. A constant visual quality is consequently guaranteed for the product.

A distinction can be made between synthetic and natural colourings with respect to the colourings normally used for foodstuffs. Among the most important synthetic food colourings are orange yellow S (E110), quinoline yellow (E104), azorubine (E122), allura red (E129), tartrazine (E102) and cochineal red A (E124). These colourings are suspected, however, of causing Attention Deficit Hyperactivity Disorder (ADHD) in children. These colourings can furthermore cause allergies and allergy-like symptoms. Not least significantly, the azo colourings among them are still suspected of being carcinogenic, because carcinogenic arylamine components can be released when the colourings are metabolized in the body. Against the background of these health risks, the ever stricter foodstuff regulations and the consumer's increasing health awareness, there is naturally more and more of a trend towards the use of natural colourings, such as β-carotene (E160a), capsanthin (E160c), lycopene (E160d) and lutein (E161b).

Because these natural colourings are fat-soluble, a formulation with emulsifying agents is necessary in order to allow solubility in water-based foodstuffs. Particularly in beverages, it is moreover necessary to provide formulations that are stable at low pH levels and that permanently guarantee a uniform distribution of the colouring in the acidic aqueous medium.

WO 2007/047237 relates to emulsifying agent combinations for manufacturing microemulsions in order to incorporate water-insoluble components into foodstuffs and beverages. In this process, mixtures of emulsifying agents with low HLB values from 1 to 5, medium HLB values from 6 to 8 and high HLB values from 9 to 17 are used. However foodstuffs that contain microemulsions of this type have an unpleasant aftertaste that is due to the emulsifying agents used.

WO 2004/023900 relates to formulations of water-insoluble solids in beverages. It describes emulsifying agent combinations of polysorbates and sorbitan esters. The water-insoluble solids are first dissolved in a non-aqueous solvent and then reworked with the addition of emulsifying agents into a concentrate beverage that can be re-diluted into a clear beverage. The use of solvents such as propylene glycol, ethanol and benzyl alcohol is, however, restricted in quantity and application and is not suitable for the formulation of high-coloured emulsions.

Compositions for manufacturing optically clear products are disclosed in U.S. Pat. No. 6,509,044. The lipophilic constituents of the composition are emulsified after being dissolved in a suitable oil, with the use of emulsifying agents with HLB values from 10 to 18. In particular, mixtures of polysorbate 60 and sucrose stearate and mixtures of polysorbate 60, sucrose stearate and polyglycerol ester of a fatty acid are described, because polysorbate 60 has the least objectionable aftertaste. The compositions contain only very small quantities of colouring (maximum 0.15% β-carotene), however, and only very little oil phase (maximum 0.3%) so that oleoresins with a greater content of oil phase cannot be emulsified in a stable manner.

The object of the present invention is to provide a composition that has good colour characteristics, that is microbially and physically stable, that is homogenous and flowable, that does not clot or cream up in acidic beverages when left standing at room temperature for a longer time, and that is tasteless.

This object is solved by a composition that comprises (a) at least a colouring, (b) at least a first emulsifying agent selected from the group of polysorbates, and (c) at least a second emulsifying agent selected from the group of esters of mono- and diglycerides of edible fatty acids, whereby the weight ratio of (b) to (c) amounts to 5:1 to 40:1.

The object is also solved by a method for manufacturing the composition according to the invention, whereby the method is characterised in that the components are mixed with one another.

The object is also solved by the use of the composition according to the invention for manufacturing foodstuffs and semi-finished products of foodstuffs.

Preferred embodiments are described in the dependent claims 2 to 11 and 14.

If the composition according to the invention is used in a beverage, a clear beverage is obtained.

According to the invention, the term “clear” is understood as a liquid that has no turbidity. Normally such turbidity is caused by small particles that have a refractive index that differs from that of the carrier substance and that scatter light. According to the invention, the turbidity in liquids is given in FNU (Formazine Nephelometric Units). The turbidity is measured with a Hach Lange Nephla nephelometer (measurement method: 90° light-scattering photometry, measurement method: DIN EN 27027 or ISO 7027, measurement wavelength: 860 nm, measurement range: FNU 0.001 to 1000). Normally a solution with an FNU level of less than 20 FNU is said to be clear. The terms “clear”, “blank” and “transparent” are used identically and are consequently interchangeable.

According to the invention, the term “stable” is understood to mean that the composition according to the invention does not change the characteristics when cold-stored at <10° C. for a period of one year, e.g., does not display increased turbidity in the colouring of the beverages.

According to the invention, the term “homogenous” is understood to mean that the composition according to the invention is macroscopically uniform.

The term “flowable” means that the composition according to the invention can be conveyed on an industrial scale through conduit systems with conventional (positive displacement) pumps.

According to the invention, the term “tasteless” is understood to mean that the composition according to the invention does not change the taste of the foodstuff that it is used to manufacture.

All customary colourings known to the person skilled in the art can be used as colourings. According to the invention, preferably carotenoids such as α-, β-, γ-carotene, bixin, norbixin, annatto, capsanthin, capsorubin, paprika oleoresin, lycopene, β-Apo-8-carotenal and β-Apo-8-carotenoic acid ethyl esters (E160a to f), xanthophylls, such as flavoxanthin, lutein, cryptoxanthin, rubixanthin, violaxanthin, rhodoxanthin and canthaxanthin (E161a to g), lutein ester, lutein oleoresin, Mg-chlorophyll (E140), Cu-chlorophyll and Cu-chlorophyllin (E141), oleoresins containing chlorophyll and Cu-chlorophyll, carminic acid (E120), curcumin (E100) and combinations thereof can be used. Particularly preferred colourings are β-carotene, paprika oleoresin, Cu-chlorophyllin, particularly β-carotene and paprika oleoresin.

Paprika oleoresin is an oil-soluble extract of paprika that contains capsanthin, capsorubin and β-carotene as its main colour constituents. Oleoresins containing chlorophyll are acquired from the leaves of stinging nettles, spinach, lucerne and / or the mulberry tree.

According to the invention, a polysorbate, i.e., a polyoxyethylene (20) sorbitan that is esterified with fatty acids, is used as the first emulsifying agent. The number that follows the term “polysorbate” refers to the specific fatty acid. Consequently, polysorbate 20 corresponds to polyoxyethylene (20) sorbitan monolaurate (E432), polysorbate 40 corresponds to polyoxyethylene (20) sorbitan monopalmitate (E434), polysorbate 60 corresponds to polyoxyethylene (20) sorbitan monostearate (E435), polysorbate 65 corresponds to polyoxyethylene (20) tristearate (E436), polysorbate 80 corresponds to polyoxyethylene (20) sorbitan monooleate (E433) and polysorbate 85 corresponds to polyoxyethylene (20) sorbitan trioleate.

Used as the second emulsifying agent in the composition according to the invention is an ester of mono- and diglycerides of edible fatty acids, such as acetic acid ester of mono- and diglycerides of edible fatty acids (E472a), lactic acid ester of mono- and diglycerides of edible fatty acids (E472b), citric acid ester of mono- and diglycerides of edible fatty acids (E472c), tartaric acid ester of mono- and diglycerides of edible fatty acids (472d), diacetyl tartaric acid ester of mono- and diglycerides of edible fatty acids (E472e) and a mixture of acetic and tartaric acid esters of mono- and diglycerides of edible fatty acids (E472f).

The composition according to the invention can be formulated in a manner stable for beverages, and it is particularly stable in a beverage with a pH level of 4 or less.

In a preferred embodiment, in combination with one of the embodiments mentioned above or below, the first emulsifying agent (b) is selected from the group consisting of polysorbate 20, polysorbate 60 and polysorbate 80. More preferably, the emulsifying agent is selected from polysorbate 60 and polysorbate 80, particularly polysorbate 60.

In a further preferred embodiment in combination with one of the embodiments mentioned above or below, the ester of the second emulsifying agent (c) is selected from the group consisting of lactic acid, citric acid and tartaric acid esters of mono- and diglycerides of edible fatty acids. Preferably the ester of the emulsifying agent is a lactic acid or citric acid ester of mono- and diglycerides of edible fatty acids, particularly a citric acid ester of mono- and diglycerides of edible fatty acids.

The composition according to the invention can furthermore, in a preferred embodiment in combination with one of the embodiments mentioned above or below, contain as further additives (d) acidifying agents such as citric acid or tri-sodium-citrate; tasting agents; flavouring agents; preservatives such as potassium sorbate; fruit concentrates; fruit and plant extracts; vitamins such as vitamin C; sweetening agents; antioxidants such as tocopherol; as well as combinations of two or more additives. Preferred additives are antioxidants, preservatives, vitamins, fruit concentrates, fruit and plant extracts, and particularly preferred additives are antioxidants and preservatives.

In a further preferred embodiment in combination with one of the embodiments mentioned above or below, the composition according to the invention can contain natural and/or artificial sweetening agents. Customary natural sweetening agents are, e.g., carbohydrates such as sugar, inverted sugar syrup, glucose syrup or fructose syrup, fruit sweetener, honey and agave syrup; natural sweeteners such as stevia, rebaudiosid A, taumatine or neohesperidine; and sugar alcohols such as sorbitol, maltitol, manite, isomalt, maltitol syrup, xylitol or lactitol. Customary artificial sweetening agents are, e.g., aspartame, acesulfame, sodium cyclamate, sodium saccharin or sucralose.

The sweetening agents can be used separately or in a combination of two or more sweetening agents. The composition according to the invention particularly preferably contains sugar, inverted sugar syrup and sorbitol as sweetening agents.

In combination with one of the embodiments mentioned above or below, the composition according to the invention preferably contains 1 to 20 wt. %, more preferably 2 to 16 wt. %, particularly 4 to 10 wt. % of the component (a) relative to the total composition.

The composition according to the invention in combination with one of the embodiments mentioned above or below furthermore preferably contains 5 to 80 wt. %, more preferably 15 to 40 wt. %, particularly 20 to 25 wt. % of the component (b) relative to the total composition. If the composition according to the invention contains 5 to 80 wt. % of the component (b), it is particularly stable and flowable.

In a further preferred embodiment in combination with one of the embodiments mentioned above or below, the composition according to the invention preferably contains 1 to 5 wt. %, more preferably 1.5 to 3 wt. % of the component (c) relative to the total composition.

In a preferred embodiment in combination with one of the embodiments mentioned above or below, the weight ratio of the component (b) to the component (c) amounts to 5:1 to 30:1, more preferably 7:1 to 17:1.

In a preferred embodiment in combination with one of the embodiments mentioned above or below, the weight ratio of the component (a) to the component (b) amounts to 1:0.5 to 1:10, more preferably 1:5 to 1:6.5.

In a further embodiment in combination with one of the embodiments mentioned above or below, the composition according to the invention contains 1 to 10 wt. %, more preferably 2 to 8 wt. %, particularly 4 to 7 wt. % as the total of the component (d) relative to the total composition.

The composition according to the invention can be dissolved in water in order to obtain an aqueous colouring solution. The aqueous colouring solution of the composition according to the invention preferably contains at least 10 wt. % water, more preferably 30 wt. % to 80 wt. %, particularly 60 to 70 wt. % water relative to the total solution.

In the method according to the invention, the components (a) to (c) and, as far as oil-soluble, also component (d) are mixed while being agitated in a manner known to the person skilled in the art. Preferably the component (b) is provided, heated to 60° C., agitated together with component (a) and, where applicable, the oil-soluble component (d) and then component (c) is added and dissolved at 60 to 100° C., more preferably at 60 to 90° C., particularly at 80° C.

If the component (d) is a water-soluble component, it is dissolved in water separately in a second batch and introduced into the first batch. The component (d) is preferably dissolved in water at 40 to 60° C. and then slowly introduced into the first batch at a temperature of 60° C. while being agitated.

In a preferred embodiment in combination with one of the embodiments mentioned above or below, the composition according to the invention is additionally subjected to homogenisation at 60 to 80° C. and 200 to 1000 bar.

The composition according to the invention is used for manufacturing foodstuffs. The composition according to the invention is preferably used for manufacturing coloured beverages, fruit preparations and confectionaries.

A beverage preferably contains 0.05 to 0.3 wt. %, more preferably 0.1 to 0.2 wt. %, of the composition according to the invention.

In a preferred embodiment in combination with one of the embodiments mentioned above or below, beverages that contain the composition according to the invention have turbidity from 0 to 20 FNU, more preferably less than 10 FNU. If a beverage that is coloured with the composition according to the invention contains 5 ppm carotenoids (as β-carotene), the beverage has a turbidity of less than 10 FNU.

The present invention is explained in more detail by the following examples.

### EXAMPLES

### Example 1

| | Proportion wt. % |
|---|---|
| Polysorbate 60 | 25 |
| Tocopherol | 0.5 |
| Paprika oleoresin | 4 |
| Citric acid ester of mono- and diglycerides | 2 |
| of edible fatty acids (E472c) | |
| Water | 64 |
| Vitamin C | 4 |
| Potassium sorbate | 0.5 |

### Example 2

| | Proportion wt. % |
|---|---|
| Polysorbate 60 | 20 |
| Tocopherol | 0.5 |
| Paprika oleoresin | 4 |
| Citric acid ester of mono- and diglycerides | 2 |
| of edible fatty acids (E472c) | |
| Water | 69 |
| Vitamin C | 4 |
| Potassium sorbate | 0.5 |

First the emulsifying agent, tocopherol and paprika oleoresin are agitated with a magnetic agitator at 80° C. for 20 minutes until the oleoresin has completely dissolved. In a separate container, the water is provided, vitamin C and potassium sorbate are added and agitated at 50° C. until the solids have completely dissolved. The aqueous solution is added to the emulsifying agent mixture at room temperature and then agitated for 10 min. The obtained solution is then homogenised at 80° C. and 1000 bar.

The obtained solution is diluted in a weight ratio of 1:1000 with lemonade medium (consisting of 140 g inverted sugar, 5 g of 50% citric acid in water, 854 g of demineralised water and 0.2 g of potassium sorbate), filled into glass bottles and observed for 2 months at 20° C. There is no formation of clots or oil rings in the bottle neck.

If only citric acid ester is used as the emulsifying agent, the obtained composition has no long-term stability in the lemonade medium over a longer period of time, and instead clots after roughly 3 weeks when left standing at 20° C. If only polysorbate 60 is used as the emulsifying agent, the solution consisting of the composition and the lemonade medium becomes macroscopically inhomogeneous.

1. A composition comprising:
(a) at least a colouring,
(b) at least a first emulsifying agent selected from the group of the polysorbates, and
(c) at least a second emulsifying agent, selected from the group of the esters of mono- and diglycerides of edible fatty acids,
wherein the weight ratio (b):(c) amounts to 5:1 to 40:1.

2. The composition according to claim 1, wherein the colouring (a) is selected from the group consisting of α-, β-, γ-carotene, bixin, norbixin, annatto, capsanthin, capsorubin, paprika oleoresin, lycopene, β-Apo-8-carotenal, β-Apo-8-carotenoic acid ethyl esters, flavoxanthin, lutein, cryptoxanthin, rubixanthin, violaxanthin, rhodoxanthin, canthaxanthin, lutein ester, lutein oleoresin, Mg-chlorophyll, Cu-chlorophyll, Cu-chlorophyllin, oleoresins containing chlorophyll, carminic acid and curcumin.

3. The composition according to claim 1, wherein the emulsifying agent (b) is selected from polysorbate 20, polysorbate 60 and polysorbate 80.

4. The composition according to claim 1, wherein the ester of the emulsifying agent (c) is selected from the group consisting of a lactic acid, citric acid and tartaric acid ester of mono- and diglycerides of edible fatty acids.

5. The composition according to claim 1 that furthermore comprises an additive (d), selected from the group consisting of tasting agents, flavouring agents, acidifying agents, preservatives, sweetening agents, fruit concentrates, fruit and plant extracts, vitamins and/or antioxidants.

6. The composition according to claim 1 that contains 1 to 20 wt. % of component (a) relative to the total composition.

7. The composition according to claim 1 that contains 5 to 80 wt. % of component (b) relative to the total composition.

8. The composition according to claim 1 that contains 1 to 5 wt. % of component (c) relative to the total composition.

9. The composition according to claim 5 that contains 1 to 10 wt. % of component (d) relative to the total composition.

10. The composition according to claim 1, wherein the component (b) is polysorbate 60 and the component (c) is a citric acid ester of mono- and diglycerides of edible fatty acids.

11. The composition according to claim 1, wherein the component (a) is a paprika oleoresin.

12. A method for manufacturing the composition according to claim 1, wherein the components are mixed together.

13. A foodstuff or semi-finished product thereof comprising the composition according to claim 1.

14. The foodstuff or semi-finished product thereof of claim 13, wherein said foodstuff or semi-finished product is coloured beverages, fruit preparations or confectionaries.
